(19) United States
(12) Patent Application Publication
(10) Pub. No.: US 2009/0027223 A1
(43) Pub. Date: Jan. 29, 2009

(54) LOCATION RATING SYSTEM AND METHOD

(76) Inventor: Evan M. Hill, Sandy, UT (US)

Correspondence Address: STOEL RIVES LLP - SLC, 201 SOUTH MAIN STREET, SUITE 1100, ONE UTAH CENTER, SALT LAKE CITY, UT, 84111, US

(21) Appl. No.: 11/871,025

(22) Filed: Oct. 11, 2007

Related U.S. Application Data
(60) Provisional application No. 60/951,331, filed on Jul. 23, 2007.
(60) Provisional application No. 60/969,402, filed on Aug. 31, 2007.

(51) Int. Cl. G08B 21/00

(52) U.S. Cl. 340/686.6

(57) ABSTRACT

A user may submit a rating of a place or event through a location-aware mobile device. The location-aware mobile device may be configured to include or transmit location coordinates with the rating sent to a user ratings aggregation service. The aggregation service may receive the rating and use the coordinates to query a database to determine the rated place or event. The database may return multiple hits, in which case the user may be prompted to select the place or event to be rated from a list of proximate places or events. Where a limited time event is rated, such as a concert or play, the user rating transmitted to the aggregation service may comprise a timestamp from which the aggregation service may determine the place or event to be rated. As an inducement to submit a rating, the ratings aggregation service may provision a reward and/or promotion to a user responsive to receiving a rating from the user.

### RELATED APPLICATIONS

This Application claims priority to U.S. Provisional Application 60/951,331 entitled LOCATION RATING SYSTEM AND METHOD, filed on Jul. 23, 2007 and 60/969,402 entitled LOCATION BREAD CRUMBING AND RATING SYSTEM AND METHOD, filed Aug. 31, 2007 both of which are hereby incorporated by reference in their entirety.

### TECHNICAL FIELD

The following disclosure relates generally to a system and method to allow a user to submit a rating of a place or event from a location-aware mobile device.

### BRIEF DESCRIPTION OF THE DRAWINGS

Additional aspects and advantages will be apparent from the following detailed description of preferred embodiments, which proceeds with reference to the accompanying drawings, wherein:

FIG. 1 is a block diagram of one embodiment of a location rating aggregation system;

FIG. 2 is a flow diagram of one embodiment of a method for receiving a user rating from a location-aware mobile communication device;

FIG. 3 is a flow diagram of one embodiment of a method for receiving a user rating from a location-aware mobile communication device;

FIG. 4 is a flow diagram of one embodiment of a method for receiving a user rating from a location-aware mobile communication device;

FIG. 5 is a flow diagram of one embodiment of a method for receiving a user rating from a location-aware mobile communication device;

FIG. 6 is a flow diagram of one embodiment of a method for receiving a user rating from a location-aware mobile communication device;

FIG. 7 is a flow diagram of one embodiment of a method for providing a location-defined cue to submit a rating for a place or event;

FIG. 8 is a flow diagram of one embodiment of a method for providing a real-time cue to submit a rating for a place or event;

FIG. 9 is a depiction of an embodiment of a mobile communication device having a user interface configured to allow a user of the mobile communication device to submit a user rating through the mobile communication device;

FIG. 10 is a flow diagram of one embodiment of a method for creating a user reminder to rate a place or event;

FIG. 11 is a flow diagram of one embodiment of a method for receiving, storing, and presenting a reminder to submit a rating;

FIG. 12 is a flow diagram of one embodiment of a method for creating a reminder to submit a rating of a place or event;

FIG. 13 is a flow diagram of one embodiment of a method for receiving a reminder to submit a rating; and

FIG. 14 is a flow diagram of one embodiment of a method for providing a reminder and/or prompt to submit a rating.

### DETAILED DESCRIPTION OF PREFERRED EMBODIMENTS

The embodiments of the disclosure will be best understood by reference to the drawings, wherein like elements are designated by like numerals throughout. In the following description, numerous specific details are provided for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a computer-readable medium having stored thereon instructions that may be used to program a computer (or other electronic device) to perform processes described herein. The computer-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

Several aspects of the embodiments described will be illustrated as software modules or components. As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

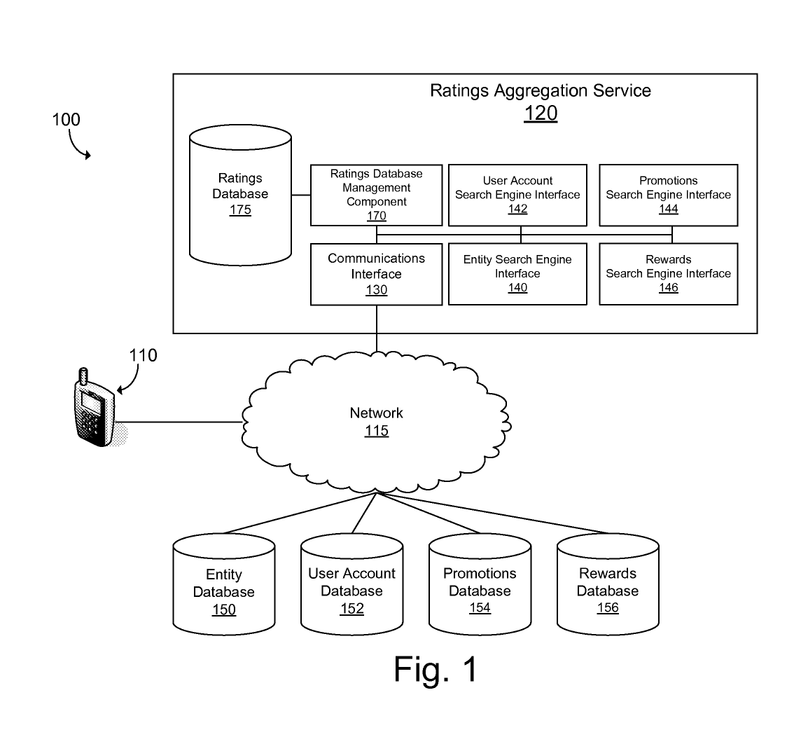

Referring now to FIG. 1, a block diagram depicts one embodiment of a system 100 to allow a location-aware mobile communication device 110 to submit a user rating to a rating aggregation service 120. As used herein, a mobile communication device may refer to a cellular telephone, radio, laptop computing device, a personal digital assistant (PDA) with or without voice communication features, a “smart phone” combining cellular phone and PDA functionality, a mobile email device, such as a Blackberry® from RIM Networks, a Wi-Fi or other wireless networking protocol enabled device, such as a Skype® phone, or the like. Mobile communication device 110 and communications interface 130 of ratings aggregation service 120 may be communicatively coupled through a network 115. Network 115 may comprise a cellular phone network, a Wi-Fi network based on an IEEE 802.11 standard, an Evolution-Data Optimized (EVDO) network, G3, or any other communications protocol capable of communicatively coupling mobile communication device 110 to communicate with other devices.

Mobile communication device 110 may be capable of determining its location coordinates. In other words, mobile communication device 110 may be said to be location-aware. In one embodiment, mobile communication device 110 may be in communication with a Global Positioning System (GPS), a location-aware wireless network, or any other system or protocol capable of determining the location of mobile communication device 110.

A user of the mobile communication device 110 may use an interface of the device to submit a rating of a place or event. Upon receiving the rating, the mobile communication device may determine location coordinates corresponding to the current position of the mobile communication device 110. These location coordinates may be included in the user rating which may be transmitted through network 115 to ratings aggregation service 120 via communications interface 130.

As used herein, a place or event may refer to a particular establishment including, but not limited to a restaurant, theater, park, church, hospital, service provider (e.g., doctor), or the like. A rating for a place may refer to a transaction occurring at a particular place and may rate available selection of products and/or services at a particular location, a return of a product or service, a customer service experience, technical knowledge of sales staff, or the like. An event may refer to any time bounded and/or limited event including, but not limited to a concert, a theater performance, a particular movie, an online-presentation, an online game, a debate, a speech, or the like. It should be understood that any manner of place, event, or transaction may be the subject of a rating under the teachings of this disclosure. As such, this disclosure should not be read as limited to any particular rating subject matter and/or rated place, event, or transaction.

Ratings aggregation service 120 may comprise entity search engine interface 140 in communication through communications interface 130 with entity database 150 through network 115. Although FIG. 1 shows a single network 115 connecting communications interface 130 to both mobile communication device 110 and entity database 150, it should be understood that network 115 may comprise various different communications networks supporting various network protocols. For example, mobile communication device 110 may be communicatively coupled to communications interface 130 via a wireless network using the EVDO protocol and may also be communicatively coupled to entity database 150 via a TCP/IP network (Internet Protocol (IP) network running Transmission Control Protocol (TCP)). Accordingly, it should be understood that this disclosure, and specifically network 115, is not limited to any particular communication method and/or protocol and that the teachings of this disclosure may be implemented using any communications method and/or protocol known in the arts.

Upon receiving a user rating from mobile communication device 110, ratings aggregation service 120 may use entity search engine interface 140 to query entity database 150. Entity search engine interface 140 may communicate with entity database 150 which may, in turn, comprise a search engine to search the contents of entity database 150. This query may comprise location coordinates of the mobile communication device 110. Responsive to the query, entity database 150 may respond with one or more places or events in the proximate area to the query coordinates. Although FIG. 1 shows entity database 150 as a separate component communicatively coupled through network 115, entity database 150 could be a component of the ratings aggregation service 120 under the teachings of this disclosure, allowing ratings aggregation service 120 to directly query entity database 150.

The ratings aggregation service 120 may receive a response from entity database 150. The response may identify one or more places or events in the “neighborhood” or proximate area of the location coordinates provided in the query. If only one place or event is returned, the ratings aggregation service 120 may associate the rating with the identified place or event. However, entity database 150 may return multiple places or events in the proximate area of the mobile communication device. In this case, the ratings aggregation service 120 may determine a most likely place or event to be rated and/or may allow the rating submitter to select the place or event to rate.

In one embodiment, the ratings aggregation service 120 may determine which of a plurality of nearby places or events is the most likely the submitter of a rating wished to rate. Making this determination may comprise: determining the closest place or event, comparing the rating to each possible place or event to determine the best contextual match (e.g., if the rating pertains to quality of wait-staff services, it is likely to be a rating for a restaurant rather than a theater or, if the rating pertains to the technical knowledge of sales staff and/or technical customer service, it is likely to be a rating for a consumer electronics store rather than a restaurant), and/or may compare a timestamp associated with the rating against the business hours of each place or event (e.g., if the rating was submitted well outside of the business hours of a place or event, it is unlikely the rating was for that particular place or event). After determining the most probable place or event, ratings aggregation service 120 may associate the rating with the place or event.

In another embodiment, where the response from entity database 150 comprises a plurality of possible places or events, ratings aggregation service 120 may cause a prompt to be transmitted to the mobile communication device 110 to prompt a user of the device to select one of the plurality of possible places or events. After receiving a response to the prompt, ratings aggregation service 120 may associate the rating with the selected place or event.

After associating the rating with a place or event, the ratings aggregation service 120 may store the associated review in ratings database 175 using database management component 170. As will be discussed below, the maintainer or ratings aggregation service 120 may make the contents of ratings database 175 available to third parties.

Ratings aggregation service 120 may comprise a user account search engine interface 142, which may be used to associate a rating with a user account. In one embodiment, a rating received by the ratings aggregation service 120 may comprise a user identifier. A user identifier may be placed into the rating by the mobile communication device 110. Alternatively, a user identifier may be included inherently as part of the communications protocol of network 115. Such a user identifier may comprise a Media Access Control (MAC) value, a Subscriber Identity Module (SIM) identifier or Universal Integrated Circuit Card (UICC) identifier from a mobile communication device, a return address, such as a network address or return phone number, or any other identifier included as part of a network protocol. Any user identifier known in the art may be used under the teachings of this disclosure. As such, this disclosure should not be read as limited to any particular user identifier or user identification technique.

After acquiring a user identifier from the rating, user account search engine interface 142 may be used to determine a user account associated with the submitter of the rating. In one embodiment, determining a user account may comprise receiving a user account from user account database 152, access to a user account, and/or access to a user profile of a user account.

In one embodiment, ratings aggregation service 120 may store ratings information in the user account database 152. Such information may comprise the place or event rated by the user, the location coordinates of the rating, and/or the rating submitted by the user.

As discussed above, communications interface 130 may communicate with user account database 152 via network 115 using any network communications method and/or protocol known in the art. In an alternative embodiment, user account database 152 may be included in ratings aggregation service 120.

Ratings aggregation service 120 may comprise promotions search engine interface 144, which may be used to provision a promotion to a submitter of a rating. As used herein, a promotion may refer to a coupon, commercial, discount, advertisement certificate, pitch, or any other promotional material for a place or event in digital or tangible form.

Responsive to receiving a rating, ratings aggregation service 120 may cause promotions search engine interface 144 to submit a query to promotions database 154 to determine one or more promotions to provision to the submitter of the rating. This query may comprise the place or event rated, the location coordinates of the rating, user account information, and the like. Responsive to the query, promotions database 154 may return one or more promotions to provision to the rating submitter. In one embodiment, the promotions may be related to the place or event rated. For example, if a user rated a theater poorly, a promotion for a nearby theater may be returned. Alternatively, if the submitter rated a concert event favorably, a promotion for a similar concert at a nearby venue may be returned. It should be understood that a variety of different promotion determining methodologies and/or techniques could be used under the teachings of this disclosure. As such, the disclosure should not be read as limited to any particular promotions determining metric or technique.

After receiving a promotion, the ratings aggregation service 120 may provision the promotion to the submitter of the rating. As used herein, provisioning and/or delivering a promotion may comprise causing tangible promotions material, such as a flyer or coupon, to be delivered to the user. Alternatively, delivering may comprise transmitting and/or emailing a digital embodiment of promotional material to the user. Ratings aggregation service 120 may use any physical and/or digital technique for delivering promotional material to a user known in the art. As such, this disclosure should not be read as limited to any particular promotions provisioning and/or delivery method.

Ratings aggregation service 120 may comprise rewards search engine interface 146 to determine a reward to provision a rating submitter. In one embodiment, ratings aggregation service 120 may provision a reward to a user responsive to receiving a rating of a place or event. As used herein, a reward may comprise a credit, certificate, cash, discount, coupon, usage credit, or any other benefit that may be provisioned to a user.

Ratings aggregation service 120 may cause rewards search engine interface 146 to query rewards database 156 to determine a reward to provision for the rating submitter. This query may comprise the place or event rated, the rating, the location coordinates of the rating, user account information, or the like. Additionally, information about the mobile communication device used to submit the rating may be included, such as information about the wireless carrier of the mobile communication device, features of the mobile communication device, and/or the network used to submit the rating. Responsive to the query, rewards database 156 may determine one or more rewards to provision to the submitter. The reward(s) may be randomly determined (e.g., a sweepstakes or prize) and/or may be based on the nature of the rating, the number of ratings submitted by the user, the place or event rated, the quality of the rating, and the like.

After receiving the reward(s) to provision to the user, ratings aggregation service 120 may provision the reward(s). As discussed above, this provisioning and/or delivering may comprise delivering a digital or tangible embodiment of the reward using any delivery method known in the art. Accordingly, this disclosure should not be read as limited to any particular reward delivery technique.

As discussed above, each user rating received by ratings aggregation service 120 may be associated with a place or event and stored in ratings database 175. Ratings aggregation service 120 may make the user ratings of ratings database 175 available via database management component 170 and communications interface 130. In this embodiment, user ratings may be made available to the proprietors of rated businesses or event promoters to receive feedback of their products and/or services. In addition, the user ratings stored in database 175 may be made available to other users of the ratings aggregation service 120 to determine whether they wish to frequent a particular place or participate in a particular event. In addition, ratings database management 170 may provide search engine functionality to database 175 to allow third parties to search for ratings associated with particular places or events and/or to search for ratings submitted by a particular user or user type.

Although FIG. 1 depicts ratings database 175, entity database 150, user account database 152, promotions database 154, and rewards database 156 as separate database components, it should be understood that these databases could be implemented as tables and/or namespaces within the same physical or logical database. Thus, references herein to a ratings, entity, user account, promotions, and rewards database may refer to the same database system. Similarly, each of databases 175, 150-156 could be implemented as a relational, XML, or X.509 directory database system under the teachings of the disclosure. As such, the disclosure should not be read as limited to any particular data storage and/or retrieval technology.

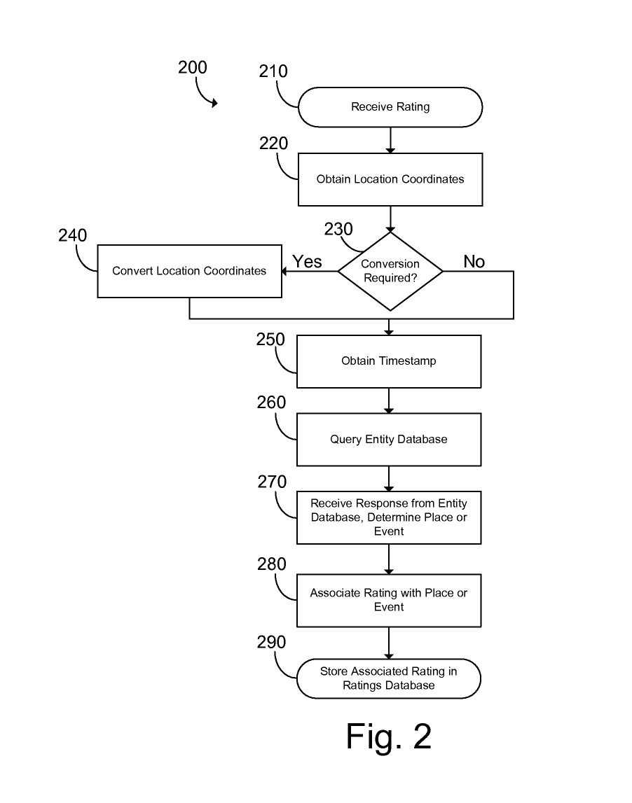

Referring now to FIG. 2, a flow diagram of one embodiment of a method 200 for receiving a user rating is depicted. At step 210, a rating may be received. As discussed above, the request of step 210 may be sent from a location-aware mobile communication device via a wireless network. The request of step 210 may comprise a rating, allowing a user to rate a location in a single step.

At step 220, location coordinates may be obtained. In one embodiment, the location coordinates may be included in the user rating received at step 210. Alternatively, the location coordinates may be transmitted from the mobile communication device in a separate message. The location coordinates received at step 220 may have been automatically determined and transmitted by the mobile communication device without requiring any user input and/or user interaction. This may allow a user of the mobile communication device to submit a rating quickly and with minimal effort.

At step 230, a determination may be made as to whether the location coordinates obtained at step 220 need to be covered into another format. There are several different location coordinate systems in use today, including, but not limited to: the World Geodetic System WGS84 coordinate system (WGS84), latitude and longitude coordinates, the geographic coordinate system, the Universal Transverse Mercator projective system (UTM), the French Lambert, Lambertlle, and Lambert92, and the Swiss CH1903. Accordingly, it may be convenient to translate and/or convert the location coordinates obtained at step 220 into a another format. If the conversion determination of step 230 is positive, the flow may continue to step 240; otherwise, the flow may continue to step 250.

At step 240, the location coordinates obtained at step 220 may be converted into one or more formats more conveniently usable by other steps of method 200. The flow may then continue to step 250.

In one embodiment, at step 250, a timestamp may be obtained. The timestamp may be transmitted as part of the rating received at 210, the location coordinates obtained at 220, or may be transmitted in a separate message. Alternatively, the method 200 may determine a timestamp from the time the rating was received at step 210 or, the timestamp may be included as part of the communications protocol used by the mobile communication device to transmit the rating. The timestamp information may be in any number of timestamp formats, including, but not limited to: so-called Unix time (number of seconds since Jan. 1, 1970), SMPTE time code, Greenwich Mean Time (GMT), or the like. Although not shown in the flow diagram of FIG. 2, the timestamp may be converted into another time format as required.

At step 260, a query may be dispatched to an entity database. In one embodiment, the entity database may be maintained by a third party and may comprise a relational database, a X.509 directory, or the like to associate a place or event with a set or range of location coordinates. As such, the entity database may return one or more places or events in the neighborhood or proximate area of the location coordinates of the query.

The query of step 260 may comprise an error margin “ε” of the location coordinates. Error margin ε may determine an error range for each coordinate such that the coordinate may be either ±ε in any direction. The margin of error ε may inform the search performed the entity database. For example, the search range of entity database may be expanded for location coordinates having a large error rate ε, whereas the search range may be reduced for smaller error rates ε.

In one embodiment, the location coordinates obtained at step 220 may comprise an elevation component. In this embodiment, the elevation component of the location coordinates may be included in the query of step 260. The entity database may use the elevation information to further refine the search criteria within the entity database. This may allow the entity database to distinguish between places or events on different floors within the same building.

The query of step 260 may comprise a timestamp obtained at step 250. This may allow the entity database to identify both the place to be rated, and a particular time-limited event occurring at the place. As used herein, a time-limited event may be any event occurring at a particular place during a particular time period. Examples of timelimited events include, but are not limited to a: concert, movie showing, play, opera, symphony, festival, race, and the like. The entity database may use the timestamp along with the location coordinates to identify the time-limited event to be rated. For example, if the location coordinates indicate that the device was located in the proximity of a park and the time stamp corresponds to a performance of a concert in the park, the entity database may associate the rating with the concert performance. In another example, if the location coordinates indicate that the device was located in the proximity of an electronics store, the entity database may associate the rating with the purchase and/or transaction occurring at the particular store. In this case, the rating may pertain to the customer service experience at the store, service received on a product, or the like.

At step 270, a response specifying the place or event to be rated is received. As discussed above, the entity database may return multiple possible places or event depending upon the breadth or the search query, the error margin ε, whether timestamp information was submitted, the density of places or events in a particular location, and the like. If multiple results are returned, the entity search engine interface 140 may determine the most probable place or event using various likelihood and/or probability determining techniques. As discussed above, the most likely place or event may be determined in a number of different ways, such as: proximity, time, nature of the rating (e.g., rating and place or event context), elevation, and the like.

At step 280, the rating received at 210 may be associated with the place or event determined at step 270. In one embodiment, associating a rating with a place or event may comprise linking the rating to an identifier of the place or event. In this embodiment, the identifier of the place or event may be a unique identifier as used in a relational database and/or X.509 directory. In an alternative embodiment, a structural association in a data structure may be made, such that the storage location of the rating within a database is determined by the associated place or event. Such association may be performed in the database itself, or may be performed by a database management component. It should be understood that there are numerous ways of associating data known in the art, any of which could be employed under the teachings of this disclosure. As such, this disclosure should not be read as limited to any particular data association technique and/or methodology.

At step 290, the associated rating may be stored in a ratings database. In one embodiment, the ratings database may allow access to the associated ratings stored therein. Such access may be allowed or denied based upon the security preferences of the maintainer of the ratings database.

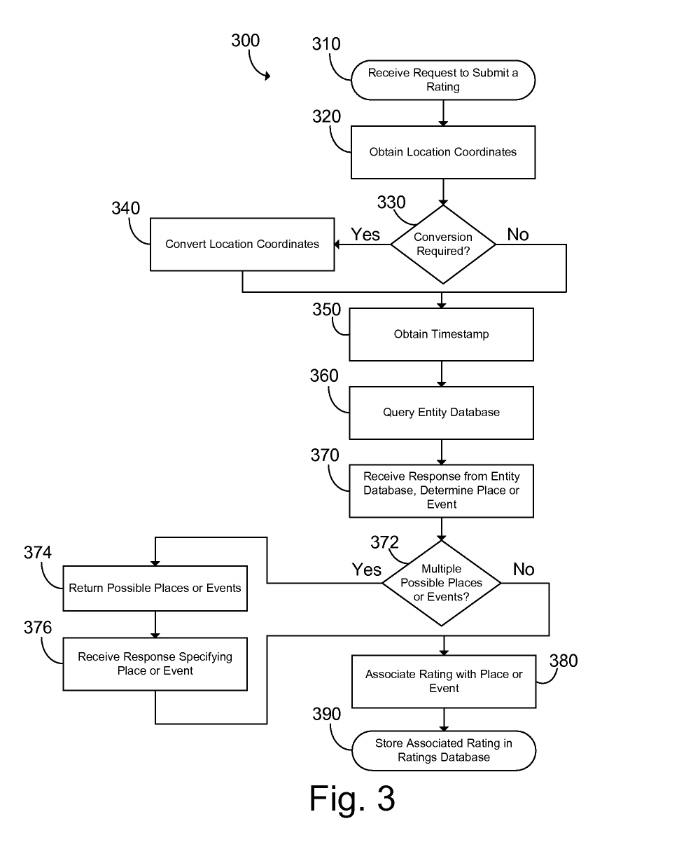

Referring now to FIG. 3, a flow diagram of one embodiment of a method 300 for receiving a user rating is depicted. At step 310, a request to submit a rating may be received from a user. As discussed above, the rating received at step 310 may have originated from a location-aware mobile communication device in wireless communication with a computing system implementing method 300 and may comprise a location rating. The request of step 310 may comprise location coordinates of the mobile communication device automatically transmitted with and/or inserted into the rating by the location-aware mobile communication device.

At step 320, the location coordinates may be obtained from the rating or a separate message transmitted from the location-aware mobile communication device. At step 330, method 300 may determine whether the location coordinates should be converted to one or more other formats. If the determination is negative, the flow may continue to step 350. If the determination is positive, the flow may continue to step 340 where the coordinates may be translated and/or converted into an appropriate format. The flow may then continue to step 350.

At step 350, a timestamp may be obtained from the rating received at step 310. As discussed above, the location-aware mobile communication device originating the user rating received at step 310 may transmit and/or include a timestamp with the user rating. Alternatively, a timestamp may be determined from the underlying communications method and/or protocol used to transmit the rating of step 310.

At step 360, an entity database may be queried. The query of step 360 may comprise the location coordinates obtained at step 320 and/or converted at step 340 and an error margin ε. The query may comprise a timestamp obtained at step 350. Responsive to the query, the entity database may determine one or more possible places or events to be rated.

At step 370, a response to the query of step 360 may be received. As discussed above, the response may comprise one or more places or events in proximity to the provided location coordinates. At step 372, the response may be examined to determine whether one or more possible subjects of the rating were determined. If more than one possible place or event was returned, the flow may continue to step 374. If only one place or event was returned, the flow may continue to step 380.

At step 374, a listing of the plurality of places or event may be transmitted to the submitter of the rating. The listing may be received by the mobile communication device, which, in turn, may prompt a user of the device to select one of the listed places or events to rate.

At step 376, a response to the transmission of step 374 may be received. The response may specify one of the places or events included in the list of step 374. Alternatively, a user of the mobile communication device may have supplied the name of another place or location she wishes to associate with the rating received at step 310.

At step 380, the rating received at step 310 may be associated with the place or event specified at step 370 or 376. As discussed above, the associating of step 380 may be done using any data relation method and/or technique known in the art.

At step 390, the associated rating may be stored in a ratings database. The ratings database of step 390 may be made accessible to third parties at the discretion of the database maintainer.

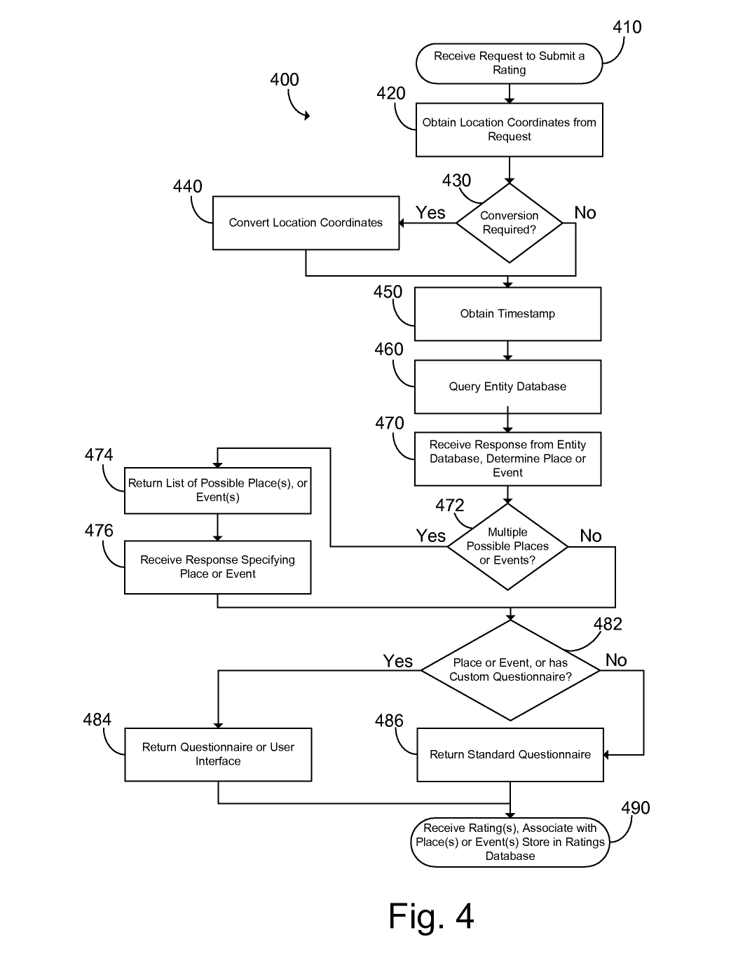

Referring now the FIG. 4, a flow diagram of one embodiment of a method 400 for receiving a user rating is depicted. At step 410, the method 400 may receive a request to submit a rating.

At step 420, location coordinates may be obtained. The location coordinates obtained at step 420 may be included in the request received at step 410 or may be transmitted from a mobile communication device in a separate message. As discussed above, at steps 430 and 440, the location coordinates may be converted into a different format if desired.

At step 450, a timestamp associated with the request received at step 410 may be obtained. The timestamp may be included in the request of step 410, the location coordinates of step 420, or may be received in a separate message.

At step 460, an entity database may be queried to determine the place or event associated with the request received at step 410. As discussed above, the query of step 460 may comprise the location coordinates, elevation information, and/or a timestamp. At step 470, a response to the query may be received. The response of step 470 may specify one or more places or events corresponding to the query of step 460.

At step 472, the method 400 may determine whether the response from entity database comprises multiple possible places or events. If the determining is positive, the flow may continue to step 474; otherwise, the flow may continue to 482.

At step 474, a listing of the plurality of places or events may be transmitted to the mobile communication device to allow a user of the device to select the place or event to be rated. At step 476, a response specifying one of the places or events may be received. In one embodiment, the response may specify one of the places or events transmitted at step 474. In another embodiment, the user of the mobile communication device may enter a place or event not included in the list of places or events transmitted at step 474.

At step 482, the method 400 may determine whether a custom questionnaire is associated with the place or event to be rated. If the determining is positive, the flow may continue to step 484 where the questionnaire may be transmitted to the user; otherwise, the flow may continue to step 486. In one embodiment, the determining of step 482 may comprise determining whether the mobile communication device which transmitted the request to submit a rating at step 410 is capable of displaying the questionnaire.

At step 484, a custom questionnaire specific to the place or event to be rated may be transmitted to the mobile communication device. The questionnaire may allow a user to enter ratings tailored to a particular type of place or event. For example, if a restaurant were to be rated, the questionnaire may comprise questions pertaining to the quality of wait-staff, the food, the ambiance, and the like. In contrast, a questionnaire for a theater may be comprising different questions relating to the comfort of the seating, theater cleanliness, concessions, and the like. The questionnaire may be specific to a particular brand, allowing a user to rate features specific to the brand, or deemed to be particularly important to the brand. The questionnaire of step 484 may comprise a user interface which may include graphical cues and/or user interface elements to facilitate entry of the rating the format specified by the place or event. The questionnaire user interface may comprise graphical cues to facilitate ratings entry and may comprise graphical branding assets.

The questionnaire returned at step 484 may allow a user to rate multiple aspects of a particular place or event. For example, if the user were to rate a concert, the questionnaire may prompt the user to rate both the concert venue and the concert performance. In this embodiment, a user may be prompted to respond to questions relating to the quality of the venue, such as its cleanliness, the quality of the staff, the acoustics, etc. In the same questionnaire and/or interface, the user may also rate the concert performance with questions relating to aspects of the performance (e.g., the quality of the performance).

At step 486, a standard or general purpose ratings questionnaire may be returned to the user. The general purpose ratings questionnaire may allow a user to rate general aspects of the place or location. In one embodiment, entity database may categorize the place or event to be rated. In this embodiment, the generic rating prompt may comprise questions directed to a particular type of place or event.

At step 490, a response to the questionnaire transmitted at step 484 or step 486 may be received. The ratings information in the response may be associated with the place or event to be rated and may be stored in a ratings database as described above. If a questionnaire was used which allowed the user to rate multiple aspects of the place or event (e.g., rate the venue and the concert performance), the association of step 490 may associate each rating with the corresponding place or event. For example, ratings pertaining to the venue may be associated with the venue, and ratings regarding the performance may be associated with the performer.

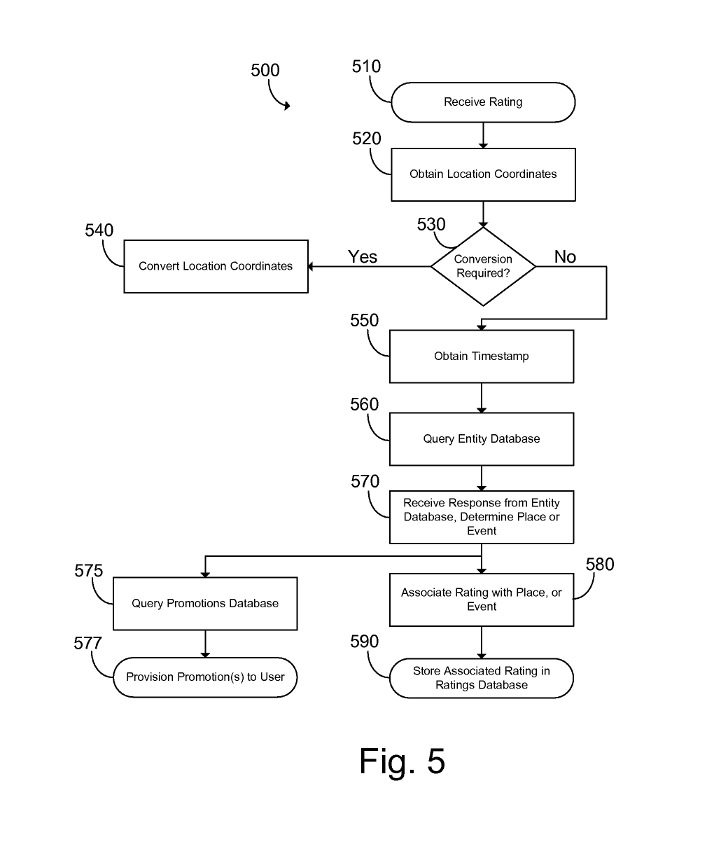

Referring now the FIG. 5, a flow diagram of one embodiment of a method 500 for receiving a user rating is depicted. At steps 510, 520, 530, 540, 550, 560, 570, 580, and 590 a user rating may be received, location coordinates may be obtained (and converted if desired), a timestamp may be obtained, a place or event to be rated may be determined, a rating may be associated with the place or event, and the associated rating may be stored in a ratings database as discussed above in conjunction with FIG. 2.

At step 575, method 500 may query a promotions database to determine one or more promotions to provision to the submitter of the user rating received at step 510. The query of step 575 may comprise the location coordinates of the rating, the rating timestamp, and/or the place or event being rated. The promotions database may determine a promotion to provision to the user based on the information of the step 575 query. In one embodiment, the promotions database may return a promotion targeted to the submitter of the rating. For example, if the rating is negative and is associated with a particular location (e.g., golf course), the promotions database may determine a promotion for another nearby course since it is likely that the submitter would be interested in an alternative place to play. Similarly, if the rating is positive and is associated with a theater, the promotions database may determine a promotion for a nearby restaurant since the submitter will likely be in the area and may be interested in dinner following the show. It should be understood that any number of different promotions determining techniques and/or methodologies could be used under the teachings of the disclosure.

At step 577, the promotion determined at 575 may be provisioned to the submitter of the rating. As discussed above, such provisioning and/or delivery may comprise delivering a tangible instantiation of the promotion to the user via, for example, mail delivery. Alternatively, the promotion may be provisioned in digital form and may be delivered via email, a network connection, a text message, SMS messaging, or any other method and/or technique of delivering digital promotional material known in the art. It should be understood that any promotions provisioning and/or delivery methodology and/or technique could be used under the teachings of this disclosure.

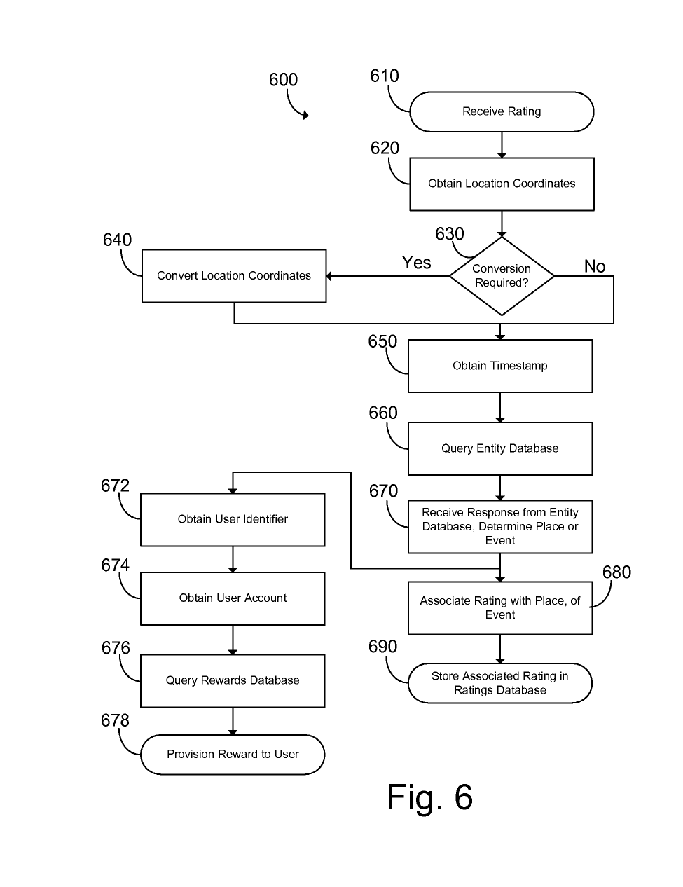

Referring now to FIG. 6, a flow diagram of one embodiment of a method 600 for receiving a user rating is depicted. At steps 610, 620, 630, 640, 650, 660, 670, 680, and 690 a user rating may be received, location coordinates may be obtained (and converted if desired), a timestamp may be obtained, a place or event to be rated may be determined, the rating may be associated with the place or event, and the associated rating may be stored in a ratings database as discussed above in conjunction with FIG. 2.

At step 671, method 600 may acquire a user identifier associated with the rating received at step 610. As discussed above, the user identifier may be transmitted as part of the user rating of step 610, may be transmitted in a separate message, or may be inherently included in the communications protocol used to transmit the rating of step 610. The disclosure encompasses all techniques and/or methodologies for obtaining a user identifier known in the art.

At step 673, after obtaining a user identifier at step 671, a user account database may be queried to determine a user account associated with the rating submitter. The user account database may comprise a relational database, and X.590 directory, or the like. The user account may be obtained at step 673 by any account determining technique known in the art.

At step 675, method 600 may query a rewards database to determine one or more rewards to provision to user account identified at step 673. The query of step 675 may comprise the user account information obtained at step 673, the location coordinates obtained of the rating, the rating timestamp, and/or the place or event being rated. The rewards database may determine a reward to provision to the user based on the information of the step 675 query. In one embodiment, the rewards database may return a randomly selected reward (e.g., a sweepstakes style reward). In another embodiment, a reward relating to the mobile communication device used to transmit the rating may be determined. Such an award may comprise usage credits for the mobile communication device, such as additional phone system or long-distance usage minutes, text messaging credits, ring-tone downloads, or any other benefit and/or credit relating to the mobile communication device. In another embodiment, the reward may correspond to the place or event being rated. For example, if the user rated a movie theater, the reward may comprise a credit for a concession at the theater and/or a discount on a movie ticket. In other embodiments, the reward may be based upon the number of ratings submitted by the user or some other aspect of the user account. For example, each time the user submits a certain number of legitimate and/or useful ratings, the reward database may determine a reward for the user. This reward may increase in value as the user submits more and more ratings. In another embodiment, the reward may relate previous ratings submitted by the user.

In another embodiment, the reward determined at step 675 may be modified based upon feedback from other users. As discussed above, the user ratings may be stored in a ratings database at step 690. Also as discussed above, the maintainer of the database may allow third parties to access the database. In one embodiment, the ratings database may allow other users to comment on and/or rate other users' ratings of places and events. Such secondary ratings may be useful in finding and removing “spam” and/or “astroturfing.” As used herein, a spam or astroturf rating may refer to a rating submitted as part of a public relations campaign that seeks to create the impression of being spontaneous, grassroots type behavior. Such ratings may be identified by other users of the system and/or the rating services maintainers by detecting an unusual surge in the number of ratings submitted for a particular place or location and/or detection of a homogeneous and/or apparently contrived ratings. Additionally, analysis of the origin of the ratings (e.g., the IP address of the originating device) may indicate an astroturfing and/or spamming campaign. Upon detection of an invalid rating, the reward provisioned for the submitter of the invalid rating may be retracted. In contrast, if secondary ratings by other users indicate that the ratings of a particular user are especially useful, an additional reward may be given to the user to encourage the user to continue contributing to the ratings system at step 671.

At step 677, the reward determined at step 675 may be provisioned to the user. The reward may be provisioned as discussed above in conjunction with the provisioning and/or delivering of a promotion. The reward may be provisioned via a digital or tangible delivery of the reward to the user. The delivery of step 677 may comprise any delivery technique and/or methodology for delivering tangible and/or digital materials known in the art. Additionally, either the reward determined at step 671, or the promotion of FIG. 5, may be associated with the user account identified at step 673. In this embodiment, provisioning and/or delivering may comprise storing the reward and/or promotion in the user account and/or profile for access by the user. For example, where the reward pertains to usage credits for a mobile communication device, the reward may by provisioned by crediting the user's account with a network carrier and/or provider for the mobile communication device.

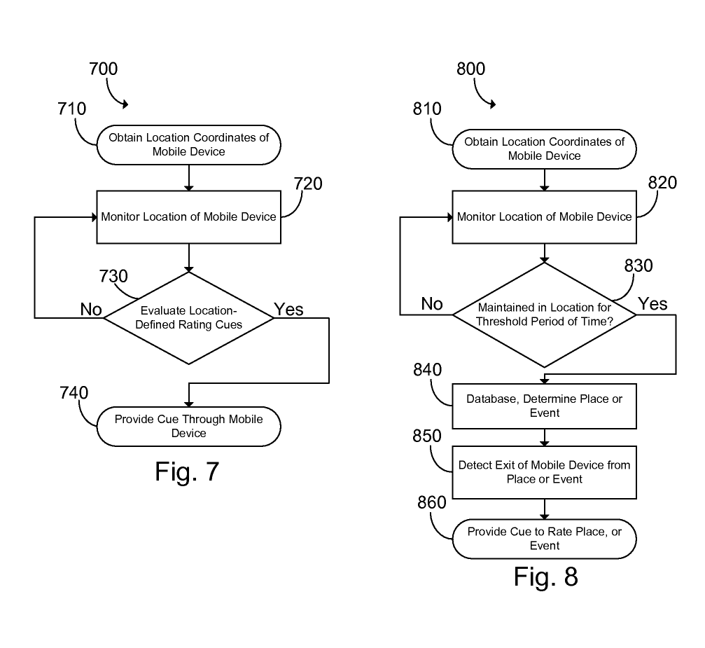

Referring now to FIG. 7, a flow diagram of one embodiment of a method 700 for providing a location-aware reminder to rate a place or event on a mobile communication device is depicted. At step 710, the location coordinates of a mobile communication device may be obtained. In one embodiment, process 700 may be performed by a ratings aggregation service. In this embodiment, step 710 may comprise receiving the location coordinates of the mobile communication device via a network connection. This may be done in any number of ways. For example, the location-aware mobile communication device may be configured to transmit its location coordinates to the ratings aggregation service at a predetermined time interval. In another embodiment, a process running on the mobile communication device may obtain the location coordinates. As above, this may be done by an internal process by periodically obtaining location coordinates from the mobile communication device.

At step 720, the location coordinates obtained at step 710 may be monitored to determine the location of the mobile communication device. As discussed above, a process running on the mobile communication device may be configured to transmit its location coordinates at a pre-determined interval (e.g., every 10 minutes). Alternatively, a process running on the mobile communication device may be configured to obtain the location coordinates at a predetermined interval. Accordingly, process 700 may determine the location of the mobile communication device, the approximate time period the mobile communication device has been in a particular location, and/or the direction the mobile communication device is traveling.

At step 730, method 700 may compare the location of the mobile communication device against one or more location-defined rating cues. As user herein, a rating cue may be associated with a particular place or event and may be defined by one or more location coordinates and a time-range. The location coordinates may define a “geofence” defining a location around the place or event. For example, if one location coordinate is used, the geofence may comprise a location coordinate and proximity threshold. A mobile communication device could be deemed to be within the geofence if the distance between the defined location coordinate and the coordinates of the mobile communication device are within a proximity threshold “τ.” If the distance between the coordinate and the mobile communication device is less than τ, the device may be deemed to be in the proximity of the place or event. If the distance is greater than τ, the device may be deemed to be outside of the proximity of the place or event. In another embodiment, a geofence may comprise 3 or more location coordinate points. The points may, taken together, may define a contiguous geographic area. As such, a mobile communication device may be deemed to be within the geofence defined by the points if the mobile communication device's coordinates fall within the area thereby defined. Otherwise, the mobile communication device may be deemed to be outside of the geofence.

A rating cue may be either stored on a mobile communication device or a ratings aggregation service. For example, as discussed above, a promotion or reward associated with a particular place or event may comprise a rating cue. Such a promotion or reward may be provisioned to a user by digitally transmitting the promotional material, including the cue, to the user's mobile communication device and/or may comprise associating the cue with a user account.

A rating cue may comprise a time-range, such that, even if a mobile communication device is within a proximity τ and/or the geofence of the rating cue, the cue may not be triggered unless the current time is within the cue's time-range. The time-range may limit the cues to appropriate time periods. For example, a location-defined cue associated with a restaurant may comprise a time range limiting the cue to dinner hours when the restaurant is open.

Returning to step 730, each of the one or more location-defined rating cues may be evaluated with respect to the current time and location of the mobile communication device. As discussed above, the evaluation of step 730 may be performed on the mobile communication device and/or a ratings aggregation service. An evaluation performed on the mobile communication device may comprise evaluating the conditions of each rating cue stored on the device. An evaluation performed on the ratings aggregation service may comprise evaluating each rating cue associated with a user account and/or selected promotional rating cues. Such promotional ratings cues may comprise ratings cues that the ratings aggregation service determines the user may be interested in. For example, if the user has submitted favorable ratings for a particular type of restaurant in the past, the ratings aggregation service may cue the user to visit and/or rate a nearby restaurant of the same type.

At step 730, if the conditions of one or more of the location-defined cues are satisfied, the flow may continue to step 740. Otherwise, the flow may return to step 720 where the method 700 may continue to monitor the mobile communication device.

At step 740, the mobile communication device may cue a user of the device. If the location-defined rating cue is stored on a ratings aggregation service, a message to cause the mobile communication device to display the cue may be sent to the mobile communication device. Step 740 may cause the mobile communication device to display a prompt on a user interface of the mobile communication device. The prompt of step 740 may comprise: modifying the contents of a user interface display, causing a tactile “rumble effect” to be produced, emitting audio, or the like. The prompt of step 740 may comprise any one or a combination of any prompting method and/or technique known in the art. The prompt produced at step 740 may comprise informing a user of the device to submit a rating for a place or event specified in the location-defined cue evaluated at step 730. The cue may comprise instructions on how to reach the place or event specified in the cue.

In one embodiment, the cue of step 740 may comprise a promotion relating to the place or event to be rated. For example, if the cue of step 740 were to rate a restaurant, the cue could comprise a promotion giving the user of the mobile communication device a free dessert coupon for use at the restaurant.

Referring now to FIG. 8, a flow diagram of one embodiment of a method 800 for providing a real-time cue to rate a place or event is depicted. At step 810, the location coordinates of a mobile communication device may be obtained. As discussed above, the location coordinates may be obtained from the mobile communication device at a predetermined time interval. In this embodiment, the mobile communication device may be configured to transmit its location coordinates to a ratings aggregation service at a predetermined interval.

At step 820, method 800 may monitor the location of the mobile communication device. Since the location coordinates may be transmitted at a periodic interval, method 800 may determine how long the mobile communication device has been maintained at a particular place or event.

At step 830, method 800 may determine whether the mobile communication device has been maintained in a particular place or event for a threshold period of time. The determination of step 830 may indicate whether a user of the mobile communication device has had sufficient time to experience the place or event. For example, the threshold of step 830 may be 20 minutes, which allow sufficient time for a user to dine at a restaurant, watch a movie, and/or attend a concert. If the mobile communication device has been maintained at a particular place or event for a sufficient period of time, the flow may continue to step 840. Otherwise, the user of the mobile communication device may not have had sufficient time to experience the place or event. As such, method 800 may not prompt the user to rate the place or location and may continue to monitor the mobile communication device at step 820.

At step 840, the place or event where the mobile communication device is located may be determined. As discussed above, determining the place or event may comprise querying an entity database with the location coordinates of the mobile communication device.

At step 850, method 800 may detect the exit of the mobile communication device from the proximity of the place of event determined at step 840. This detection may be possible since, as discussed above, the mobile communication device may be configured to periodically transmit its location coordinates. As such, the detection of step 850 may occur once the coordinates of the mobile communication device leave the proximity of the place or event.

At step 860, method 800 may cause the mobile communication device to display a cue to a user of the mobile communication device. The cue may request that the user rate the place or event determined at step 840. For example, if step 840 determined that the mobile communication device was located at a restaurant, step 860 may prompt the user to rate the restaurant when step 850 detects that the user has exited the restaurant.

The prompt of step 860 may comprise an inducement to submit a rating, such as granting the user a promotion or reward for submitting a rating. For example, a prompt requesting that a user rate a theater may promise to reward the submitter with a free movie ticket.

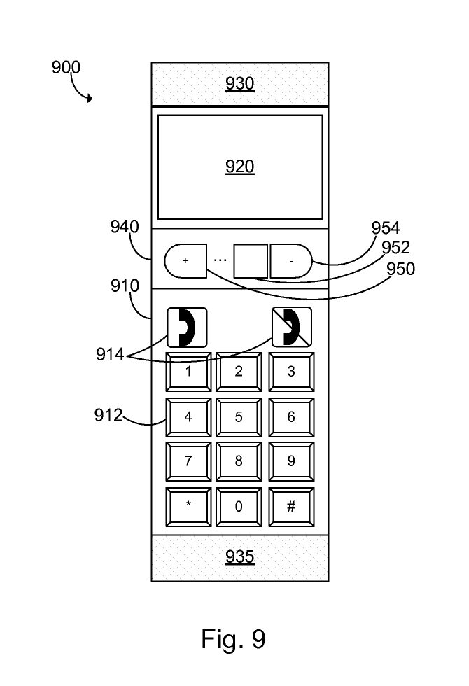

Referring now to FIG. 9, a mobile communication device 900 having a user interface 840 adapted to facilitate the submission of a user rating of a place or event using the device is shown. Mobile communication device 900 may be location-aware in that it may comprise a GPS receiver or some other means for determining location coordinates of the device.

Mobile communication device 900 may comprise a first user interface 910 to control the communications functions of the device. In one embodiment, the mobile communication device 900 may be a cellular telephone. In this case, the first user interface 910 may comprise a key entry pad 912 to allow a user of the device to enter a telephone number. The first user interface 910 may comprise dial and hang-up buttons 914 to allow a user to initiate and end a call. The first user interface 910 may comprise other communications control buttons as appropriate.

Mobile communication device 900 may comprise an audio speaker 930 and audio receiver 935 to allow a user to engage in audio communication. The user interface 910 of the mobile communication device 900 may comprise a keyboard or the like to allow a user to engage in textual communication.

Mobile communication device 900 may comprise a display screen 920. Display screen 920 may display text entered through first user interface 910, such as phone numbers, text messages, and the like.

Mobile communication device 900 may comprise a second user interface 920 configured to allow a user of the communications device to submit a rating of a place or event. In one embodiment, the second user interface 940 may comprise a positive indicator button 950 and negative indicator button 954. Selecting either positive indicator button 950 or negative indicator button 954 may cause mobile communication device 900 to transmit a user rating to a ratings aggregation service. As discussed above, the mobile communication device 900 may be configured to transmit location coordinates with the user rating. These location coordinates may be automatically determined by the location-aware communications device 900. The ratings aggregation service may, responsive to receiving the rating, determine the place or event to be rated based on the location coordinates and/or a timestamp on the message. As such, in this embodiment, a user may use second interface 940 to submit a rating of a place or event in a single step.

In another embodiment, second user interface 940 may comprise a slider control and/or range indicator 952. In this embodiment, the user of the device may move the slider control to a particular range from positive 950 to negative 954. By so moving the slider, the user may cause the mobile communication device 900 to submit a user rating. As discussed above, the rating may comprise the location coordinates and timestamp of the mobile communication device 900, allowing the recipient of the rating to determine the place or event to be rated.

In another embodiment, the second user interface 940 may comprise a portion of display screen 920. In this embodiment, display screen 920 may be a touch screen, and the buttons 950-954 may comprise touch screen buttons displayed on a portion of display screen 920. In this embodiment, a user may submit a rating by touching the appropriate area on touch screen 920.

In another embodiment, second user interface 940 may comprise a virtual user interface displayed on a portion and/or an entire viewable area of display 920. As such, second user interface 940 may comprise a software user interface accessible through first user interface 910. For example, first user interface 910 may comprise numerical buttons 912, selector buttons (not shown), a touch-pad (not shown), track-ball (not shown) or the like, which may be used to manipulate a virtual second user interface 940 viewable on display 920. In this embodiment, second user interface may comprise one or more virtual or buttons, a virtual slider, a text entry field, a virtual range selector, or any other rating indicator interface element (or combinations of these) which may be selected and otherwise manipulated by the input components of first user interface 910. In this embodiment, a user may submit a rating by manipulating the second user interface 940 using the selected input components of first user interface 910.

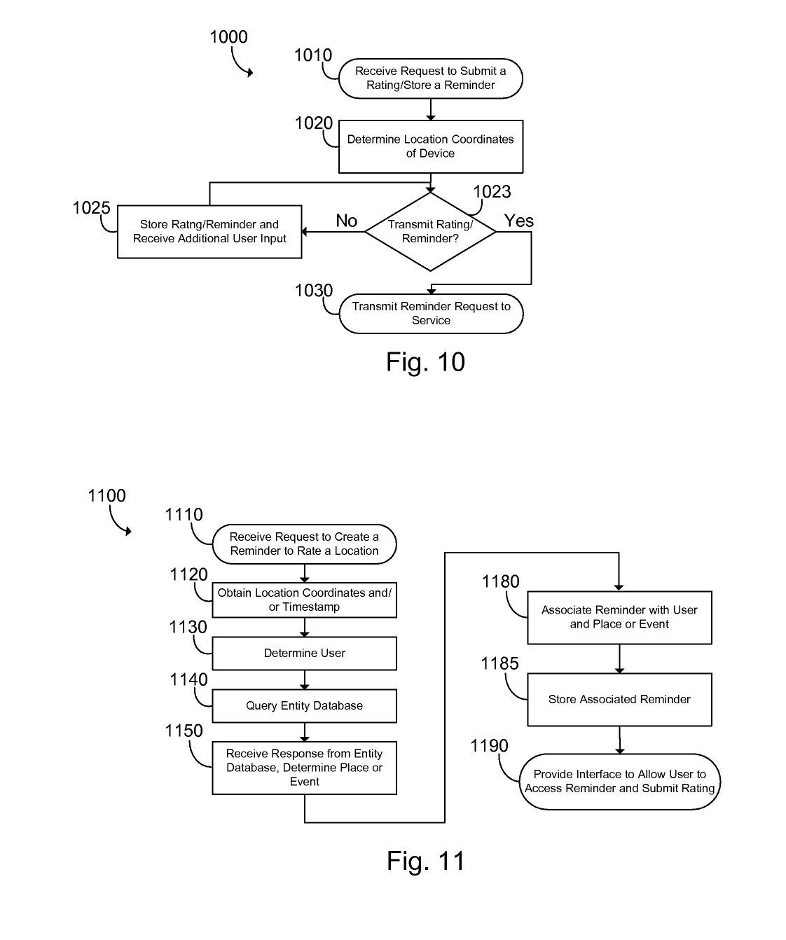

Turning now to FIG. 10, one embodiment of a method 1000 for allowing a user to create a reminder to rate a place or event is depicted. Method 1000 may allow a user to begin the process of rating a place or event on a mobile device, and to complete the rating on another device at another time. As such, a reminder to submit a review may be used if the user is interested in rating a particular place or location, but, due to time constraints or other concerns, does not want to submit the rating immediately.

Additionally, the user may wish to submit a rating on another (e.g., non-mobile) device, including, but not limited to, a personal computer running Microsoft® Windows, an personal computer from Apple Computer® running OS.X, or the like. Accordingly, the user may create a reminder to submit the review using a mobile device and complete the rating submission using another computing device. This may be desirable since the other computing device may provide the user with additional user input options, such as a full keyboard, audio and video editing capabilities, and the like. Additionally, a user may simply find it more convenient to complete the rating using an alternative computing device.

At step 1010, a user of a location-aware mobile device may select an input of the mobile device indicating a desire to create a reminder to rate a place or event. As discussed above, the location-aware mobile device may comprise a user interface specially adapted to receive such an input.

At step 1020, process 1000 may determine the location coordinates to the device. As discussed above, the location coordinates obtained at step 1020 may be in any location coordinate format known in the art. In addition, process 1000 may, at step 1020, obtain a timestamp associated with the location coordinates.

At step 1023, process 1000 may determine whether the reminder should be transmitted to a ratings aggregation service for processing. As discussed above, transmission to a ratings aggregation service may comprise utilizing a network, such as a Wi-Fi, cellular, IP network or the like. In one embodiment, the determining of step 1023 may depend on whether the mobile device has network connectivity. In this embodiment, the reminder may be transmitted if, or as soon as, the device is communicatively coupled to a ratings aggregation service. In another embodiment, mobile device may not comprise its own communication system. In this case, the device may be connected to a computer or another communication device to “synch” the device (e.g., update settings on the device, etc.) and/or to provide the device with communications functionality (e.g., for an information upload or download procedure). During the synch process, the device may be communicatively coupled to a ratings aggregation service through a network. Process 1000 may detect the presence of a network communication interface at 1023 and transmit the rating/review. Alternatively, the determining of step 1023 may be performed by a user. In this case, process 1000 may provide a user interface through the mobile device to allow a user to select when a reminder/rating is transmitted to a ratings aggregation service. If the determining of step 1023 is positive, the flow may continue to step 1030; otherwise, the flow may continue to step 1025.

At step 1025, the reminder to submit a review (including a location coordinates) may be stored on the mobile device. The storing of step 1025 may comprise storing data on a memory card, disk drive, or the like. Any data storage device and/or technique could be used under the teachings of this disclosure. Process 1000 may allow the user to add additional information to the stored reminder, including ratings information. For example, the user may enter her initial impressions of the place or event, and those impressions may be stored with the reminder and/or later transmitted to a ratings aggregation service at step 1030.

At step 1030, the location coordinates, timestamp, and/or any rating information submitted at step 1025 may be transmitted to a ratings aggregation service to processing and storage. As discussed above, the transmission of step 1030 may be made using any communication technique and/or communications interface known in the art including, but not limited to, an IP network, a Wi-Fi network, a cellular communications network, a radio network, or the like. Also as discussed above, the transmission of step 1030 may comprise user identifying information, such as a user id, a SIM id, a MAC address or the like. This information may be used by the ratings aggregation service to determine a user account associated with the request.

FIG. 11 depicts an embodiment of a process 1100 for receiving, storing, and presenting a reminder to submit a rating. At step 1110, a communications interface of process 1100 may receive a request to create a reminder to submit a rating. At step 1120, process 1100 may obtain the location coordinates and/or timestamp associated with the request. As discussed above, at step 1120, process 1100 may convert the location coordinates into another location-coordinate format.

At step 1130, user identifying information in the request may be used to determine a user account associated with the request. As discussed above, the user identifying information may comprise any user identifying information known in the art. The association of the user identifying information to a user account may comprise a query into a data storage system, such as a relational database, XML database, X.509 directory or the like. Responsive to the query, process 1100 may obtain a handle and/or reference to the user account which may allow process 1100 to access user account information and/or store information in the user account.

At step 1140, process 1100 may query an entity database to determine a place or event associated with the location coordinates and/or timestamp obtained at step 1120. As discussed above, the entity database may be maintained by a third party and may comprise a relational database, a X.509 directory, or the like to associate a place or event with a set or range of location coordinates. As such, the entity database may return one or more places or events in the neighborhood or proximate area of the location coordinates of the query.

The query of step 1140 may comprise an error margin ε which may inform the geographical scope of the search. In addition, the location coordinates of step 1120, may comprise elevation information which may be included in the step 1140 query. This may allow the entity database to distinguish, for example, between places and/or events located on different floors of the same building. The query of step 1140 may comprise a timestamp information to allow the entity database to determine a limited event occurring at a particular location.

At step 1150, a response to the query may be received. As discussed above, if multiple results are returned, process 1100 and/or the entity database may determine the most probable place or event using various likelihood and/or probability determining techniques. As discussed above, the most likely place or event may be determined in a number of different ways, such as: proximity, time, nature of the rating (e.g., rating and place or event context), elevation, and the like.

At step 1180, the reminder to submit a review may be associated with the place or event identified at step 1150. The association may also include the user account determined at step 1130. At step 1185, the associated reminder may be stored in a reminder database. The reminder database may be part of the ratings database discussed above and/or may comprise a separate data storage system.

At step 1190, process 1100 may provide an interface to allow the user identified at step 1130 to access the reminder. This interface may comprise a web-interface (e.g., a website), an application accessible through a general or special purpose computing device, and/or an interface accessible through a mobile communication device. The interface of step 1190 may allow the user to view any reminders associated with the user account in a “reminder” and/or “open ratings” list. Such a list may allow a user to view all of the reminder and/or open ratings associated with the user. The reminders and/or open ratings may comprise a description of the place or event identified at step 1150 and the timestamp information associated with the request. This may jog the user's memory to help the user to submit a relevant and accurate rating. As discussed above, the user interface of step 1190 may comprise a questionnaire specifically tailored to the place or event to be rated, tailored to the type of place or event to be rated, tailored to a particular brand, and/or may comprise a general purpose questionnaire. In addition, an interface of step 1190 comprising a website and/or adapted to be displayable on a general or special purpose computing device may allow for rich content entry, such as photograph, video, and/or audio upload. This may allow a user to submit a more detailed, media-rich rating.

The user may submit a complete rating through the user interface of step 1190, or may submit a partial rating for completion at a later time. If the user elects to submit a partial rating, the rating may remain “open” and may not be submitted to the ratings aggregation service. While a rating is open, it may be displayed in the user reminder/open list. The changes submitted by the user may be stored with the reminder/rating to allow the user to complete the rating at a later time without reentering previously submitted rating information.

The user interface of step 1190 may comprise an inducement and/or reward for submitting a rating. Such an inducement may be displayed along with the reminder to induce the user to submit a rating for the place and/or event.

As discussed above, the interface of step 1190 may comprise an interface accessible via a web-interface, an application accessible via a general and/or special purpose computer, and/or a mobile device. As such, a user may begin the process of submitting a rating for a place or event on a location-aware mobile device and complete the process on another device.

In another embodiment, the query of the entity database of step 1140 and determining of a place or event associated with the reminder at step 1150 may not occur until the user access the user interface of step 1190. In this embodiment, the reminder may be stored with the location coordinates alone. When the user accesses the user interface of 1190, the query to the entity database may be made to determine the place or event to be rated. The user may then select the place or event to be rated, enter the rating, and submit the associated rating where it may be stored in a ratings database.

The user interface of step 1190 may provide an input to allow a user to “finalize” her review. Selecting this input may allow a user to indicate that the rating has been completed and may be submitted to and stored in the ratings aggregation service. This may prevent the ratings aggregation from displaying and/or incorporating unfinished ratings into the overall ratings system. After selecting the finalize input, the rating may become un-editable and/or may only have limited editing functionality (e.g., the user may only be allowed to submit “follow up” ratings information). Additionally, after selecting the finalize input, the rating may be removed from the reminder and/or open ratings list of the user.

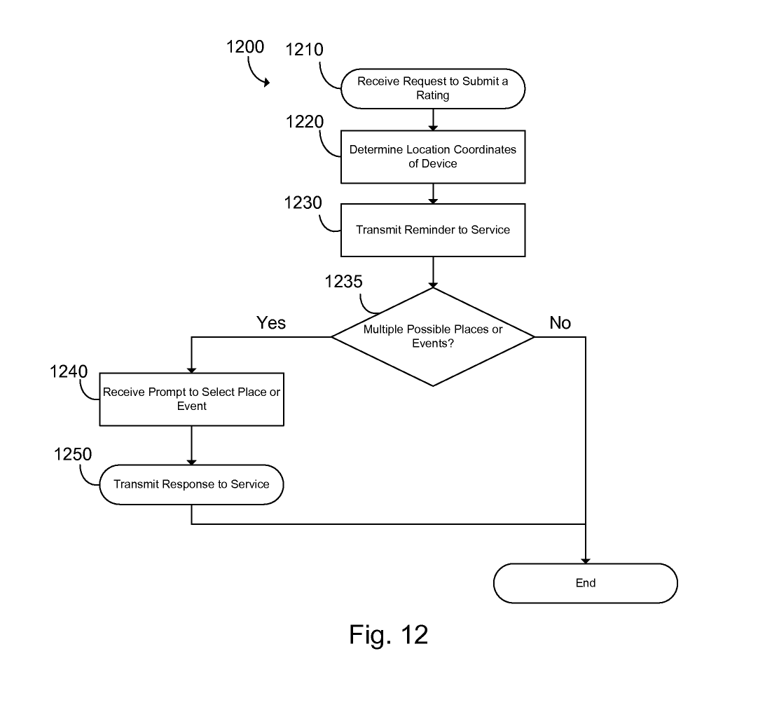

Turning now to FIG. 12, one embodiment of a process 1200 for creating a reminder to submit a rating of a place and/or event is depicted. At step 1210, a user of a location-aware mobile device may select an input and/or user interface of the mobile device to indicate a desire to create a reminder to submit a rating of a place or event.

At step 1220, responsive to the user selection, process 1200 may obtain location coordinates of the device. At step 1220, process 1200 may also obtain a timestamp and/or user identifying information.

At step 1230, the information obtained at step 1220 may be included in a request to submit a rating which may be transmitted to a ratings aggregation service. As discussed above, process 1200 may use any communications interface known in the art to perform step 1230.

At step 1235, a receiver of the request of step 1220 (e.g., a ratings aggregation service of this disclosure) may determine a place or event associated with the request. As described above, this may comprise forming a query to an entity database. The entity database may return multiple possible places or events. If so, the flow may continue to step 1240. Otherwise, if the entity database returns only a single place or event, the flow may terminate.

At step 1240, a prompt may be returned to the location-aware mobile device. The prompt may request that the user of the device disambiguate the place or event to be rated. As discussed above, the ratings aggregation service may determine multiple places and/or events in the proximity of the location coordinates obtained at step 1220. In this case, the ratings aggregation service may prompt the user to determine which place or event is to be rated. Additionally, even if only one place or event is determined by the ratings aggregation service, the user may be prompted at step 1240 to conform and/or validate the place or event identified by the ratings aggregation service.

At step 1250, the user may select an input on the locating-aware mobile device selecting and/or confirming the place or event to be associated with the reminder. Method 1200 may then terminate.

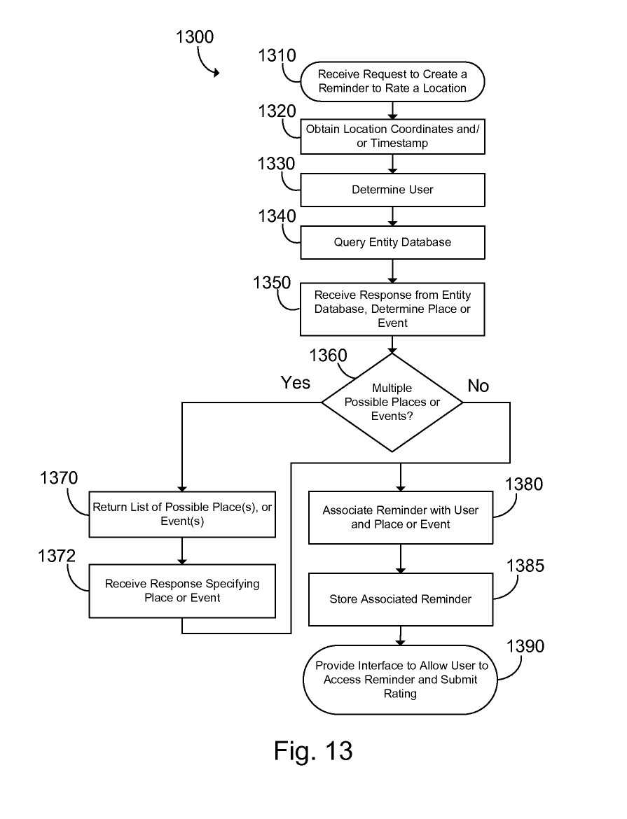

FIG. 13 depicts one embodiment of a process 1300 for receiving a reminder to submit a rating. At step 1310, process 1300 may receive a request to create a reminder to rate a place and/or event. At step 1320, location coordinates and/or timestamp information may be obtained. Additionally, process 1300 may obtain user identifying information associated with the message.

At step 1330, and as discussed above, user identifying information in the request may be used to determine a user account associated with the request. At step 1340, process 1300 may query an entity database to determine a place or event associated with the request. As discussed above, the query of step 1340 may comprise the location coordinates, elevation information, a timestamp, or the like.

At step 1350, a response to the query may be received. At step 1360, if the response of step 1350 comprises a plurality of places and/or events, the flow may continue to step 1370. Otherwise, if the response comprises a single place or event, the flow may continue to step 1380. In an alternative embodiment, the flow may continue to step 1370 even if the response of step 1350 comprises only one place or event.

At step 1370, a list of the places or events may be transmitted to the mobile communication device to allow a user of the device to select the place or event to be associated with the reminder. Alternatively, the transmission of step 1370 may comprise a single place or event, and the prompt may prompt a user of the mobile device to confirm and/or verify the identified place or event. At step 1372, a response to the query of 1370 may be received. The response may specify the place or event to be associated with the reminder to submit a rating.

At step 1380, a reminder may be created and associated with the place or event identified at step 1350 and/or specified at step 1372. The association of step 1380 may comprise associating the reminder with the user account identified and/or obtained at step 1330.

At step 1385, the associated reminder may be stored in a reminder database. As discussed above, the reminder database may be part of the ratings database and/or may comprise a separate data storage system.

At step 1390, process 1300 may provide an interface to allow the user identified at step 1330 to access the reminder. As discussed above, this interface may comprise a web-interface (e.g., a website), an application accessible through a general or special purpose computing device, and/or an interface accessible through a mobile communication device. The interface of step 1390 may allow the user to view any reminders associated with the user account. The reminders may comprise a description of the place or event identified at step 1350 and/or 1372 and the timestamp information associated with the request. As discussed above, the reminder may comprise a reward and/or promotional material to induce the user to submit a rating associated with the reminder.

As discussed above, in another embodiment, the query of the entity database of step 1340 and determining of a place or event associated with the reminder at step 1350 may not occur until the user accesses the user interface of step 1390. In this embodiment, the reminder may be stored with the location coordinates alone. When the user accesses the user interface of 1390, the query to the entity database may be made to determine a plurality of places or events to be rated. The user may then select the place or event to be rated, enter the rating, and submit the associated rating where it may be stored in a ratings database.

In one embodiment, the reward may be associated with the place or event to be rated. Since the reminder may comprise location coordinates and/or timestamp information, the reminder may verify that a location-aware mobile device associated with the rating submitter was at the place or event to be rated. This may allow process 1300 to verify and/or validate that the user submitting the rating actually was at the place or event at the specified time. Accordingly, process 1300 may prevent the submission of spam and/or astroturfing reviews.

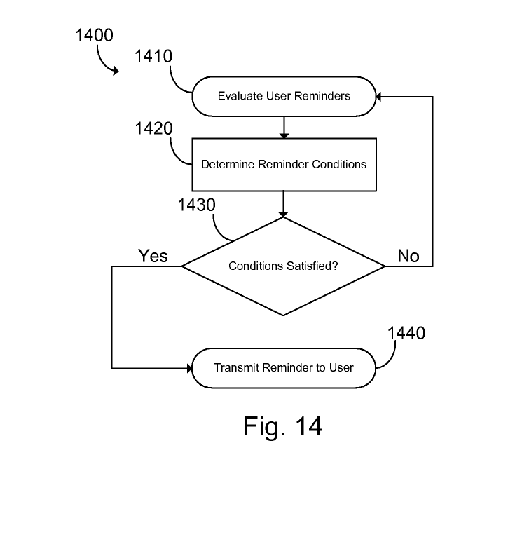

Turning now to FIG. 14, a process 1400 for providing a reminder and/or prompt to submit a rating is depicted. At step 1410, one or more reminders to submit a rating may be evaluated. As discussed above, reminders to submit a rating of a place or event may be generated by a user via a location-aware mobile device, may be pushed to the user in the form of promotional materials, and/or may be automatically generated upon detecting that a location-aware mobile device is in the proximity of a place or event for a pre-determined time period.

Process 1400 may be configured to periodically evaluate these reminders to determine whether the user associated with the reminder should be prompted to act on the reminder. Accordingly, at step 1410, all of the reminders associated with a particular user may be evaluated. As such, step 1410 may be periodically performed for each of the users associated and/or registered with the ratings aggregation service of process 1400.

In one embodiment, a user account associated with the ratings aggregation service may comprise preference information to determine whether and/or how often process 1400 should evaluate the reminders associated with the user account. Accordingly, a user may specify that process 1400 should be performed daily, weekly, monthly, or not at all.

At step 1420, any conditions relating to a reminder to submit a review may be evaluated. As discussed above, user account preference information may determine the operation of method 1400. In this embodiment, user preference information may indicate that a prompt should be pushed if a reminder has not been acted upon for a pre-determined time period (e.g., one week). Accordingly, the evaluation of step 1420 may comprise determining whether a reminder has been acted upon within the pre-determined time period.

In another embodiment, the conditions of step 1420 may comprise policies and/or preferences of the place or event to be rated. For example, the reminder may comprise a reward and/or promotion having an expiration time. In this case, the condition of step 1420 may indicate that if the expiration time is within a pre-determined threshold a prompt should be issued.

It should be understood that the reminder conditions of step 1420 may comprise any reminder conditions known in the art and should not be read as limited to any particular set of conditions and/or conditioning technique.

At step 1430, the one or more conditions associated with the reminder may be evaluated. If the evaluation of step 1430 indicates that a prompt should be issued, the flow may continue to step 1440. Otherwise, if the conditions are negative, the flow may continue at step 140 where any other reminders associated with the user may be evaluated.

At step 1440, a reminder prompt may be issued to the user. The reminder prompt of step 1440 may include, but is not limited to: an email message, a voice message, a SMS text message issued to a mobile communications device, or the like. The prompt issued at step 1440 may comprise a link or other information to allow the receiver to access the reminder and/or submit a rating associated with the reminder.

It will be clear to those having skill in the art that many changes may be made to the details of the above-described embodiments without departing from the underlying principles of the disclosure. The scope of the present invention should, therefore, be determined only by the following claims.

I claim:

1. A method comprising:
receiving at a mobile communication device a user's rating of a place or event located in proximity to the mobile communication device;
automatically obtaining location coordinates for the mobile communication device without user input; and
transmitting the rating and location coordinates to a server where the location coordinates are used to associate the rated place or event with the rating in a database.

2. The method of claim 1, wherein the mobile communication device is a cellular telephone, and wherein usage credits are added to the cellular telephone as a reward for rating the place or event.

3. The method of claim 1, wherein the mobile communication device includes a first control for indicating that the user liked the place or event and a second control for indicating that the user disliked the place or event.

4. The method of claim 3, wherein the first and second controls are touch-screen controls.

5. The method of claim 1, wherein the rating is received at the mobile communication device and transmitted to the server in response to the user activating a single control on the mobile communication device.

6. The method of claim 1, further comprising:
detecting that the mobile communication device has entered into proximity of a particular location or event; and
prompting the user to submit a rating of the particular location or event.

7. The method of claim 6, wherein location coordinates for the particular location or event are received by the mobile communication device with a promotion prior to the mobile communication device entering into proximity with the particular location or event.

8. The method of claim 1, further comprising:
detecting that the mobile communication device has left the proximity of a particular location or event; and
prompting the user to submit a rating of the particular location or event.

9. The method of claim 1, further comprising receiving a promotion at the mobile communication device for a place or event that is related to or in competition with the rated place or event.

10. The method of claim 9, wherein the promotion is at least partially determined based on the rating.

11. A method comprising:
receiving from a mobile communication device a user's rating of a place or event located in proximity to the mobile communication device;
receiving location coordinates for the mobile communication device, the location coordinates being automatically determined by the mobile communication device without user input; and
using the location coordinates to associate the rated place or event with the rating in a ratings database.

12. The method of claim 11, wherein the rating is of a place, and wherein using the location coordinates comprises:
using the location coordinates to look up the place being rated in an entity database.

13. The method of claim 11, wherein the rating is of an event occurring at a particular time, the method further comprising:
using time information associated with the rating to look up the event being rated within the entity database.

14. The method of claim 11, further comprising:
rewarding the user for rating the place or event.

15. The method of claim 14, wherein the mobile communication device is a cellular telephone, and wherein the reward comprises usage credits for the cellular telephone.

16. The method of claim 14, further comprising:
delivering a promotion to the mobile communication device for a place or event that is related to or in competition with the rated place or event.

17. The method of claim 11, further comprising:
detecting that the mobile communication device has entered into proximity of a particular location or event; and
prompting the user to submit a rating of the particular location or event.

18. A mobile communication device comprising:
at least one control for receiving a user's rating of a place or event located in proximity to the mobile communication device;
a location determination component to acquire location coordinates for the mobile communication device without user input; and
a transmission component for sending the rating and location coordinates to a server where the location coordinates are used to associate the rated place or event with the rating in a ratings database.

19. The method of claim 18, further comprising:
a first control for indicating that the user liked the place or event; and
a second control for indicating that the user disliked the place or event.

20. The method of claim 19, wherein the first and second controls are touch-screen controls.

21. A system comprising:
a communication interface for receiving from a mobile communication device a user's rating of a place or event located in proximity to the mobile communication device, as well as location coordinates for the mobile communication device that were automatically obtained without user input;
a search engine interface to look up the rated place or event in an entity database; and
a database management component for associating the rated place or event with the rating in a ratings database.

22. A computer-readable medium comprising program code for causing a computer to perform a method comprising:
receiving from a mobile communication device a user's rating of a place or event located in proximity to the mobile communication device;
receiving location coordinates for the mobile communication device, the location coordinates being automatically determined by the mobile communication device without user input; and
using the location coordinates to associate the rated place or event with the rating in a ratings database.

23. A method comprising:
receiving a request to submit a rating of a place or event from a mobile communication device, the request comprising location coordinates for the mobile communication device that are automatically determined without user input;
identifying a plurality of places or events in proximity to the mobile communication device based on the location coordinates;
sending a list of the identified places or events to the mobile communication device for use in prompting the user for a selection of one of the plurality of places or events;
receiving a selection by the user of one of the plurality of places or events;
receiving a rating by the user of the selected place or event; and
associating the user's rating with the selected place or event in a ratings database.

24. A method comprising:
receiving at a first location-aware mobile device a user's request to create a reminder to rate a place or event located in proximity to the first device;
automatically obtaining location coordinates for the first device without user input;
transmitting the request and location coordinates to a server where the location coordinates are used to generate a reminder and associate the reminder with the location coordinates in a database; and
accessing a user interface of the server using a second computing device, the user interface to display the reminder and to allow the user to submit a rating of the place or event associated with the reminder.
